(19) United States
(12) Patent Application Publication
(10) Pub. No.: US 2010/0193287 A1
(43) Pub. Date: Aug. 5, 2010

(54) Motion bicycle learning / handicap safety harness

(76) Inventor: Kyler Nathan Storm, Arvada, CO (US)

Correspondence Address: Kyler Storm, 13795 W. 71st. Place, Arvada, CO, 80004, US

(21) Appl. No.: 12/322,693

(22) Filed: Feb. 5, 2009

(51) Int. Cl. A62B 35/00

(52) U.S. Cl. 182/3

(57) ABSTRACT

A motion bicycle safety harness system for bicyclists utilizing a safety harness produced from a heavy weight fabric having a padded interior and attaching, through the use of a carabineer at the rear of the harness, to a height adjustment device. The height adjustment device uses a reinforced backing material having a series of loops allowing a custom adjustment for a variety of bicyclist heights. A nylon type roping material attaches via a carabineer from the height adjustment device and may allow for some stretching that may be advantageous to a bicyclist while performing a motion if they separated from the motion bicycle. The nylon type roping material attaches to a bearing swivel having a 360° turning radius. The attachment of the bearing swivel to a fixed position or a static cable between to poles allowing free movement of the bicyclist performing motions or traversing an obstacle course.

### CROSS-REFERENCE TO RELATED APPLICATIONS

This invention claims the priority and benefit of co-pending U.S. Provisional Patent Application No. 61/063,516 filed Feb. 4, 2008, having the same title Motion Bicycle Learning/Handicap Safety Harness and the same inventor, Kyler Storm.

### STATEMENT REGARDING FEDERALLY FUNDED RESEARCH

This invention was not made under contract with an agency of the US Government, nor by any agency of the US Government.

### FIELD OF THE INVENTION

This invention relates generally to bicycle equipment and specifically to safety devices for bicycling motions.

### BACKGROUND OF THE INVENTION

Bicycle usage has increased dramatically in recent years, leading inevitably to dramatic increases in bicycle related injuries and concurrent efforts to increase the use of bicycle safety devices.

In general, the largest single cause of bicyclist deaths is biker versus vehicle accidents, for example, around 90% of the seven to eight hundred bicyclist deaths per year in the United States are caused by accidents with vehicles. It is believed that there are forty to fifty thousand such accidents per year.

Lesser injuries, however, are actually a more serious issue, due to the fact that there are simply so many bicycle crashes and accidents which do not involve automobile impacts. In the United States, there are over one half million visits to emergency rooms every year due to bicyclist injuries. Over 10% of these in turn a head injuries. Obviously, massive efforts are made to combat such problems. Bicycle safety equipment has proliferated in recent years and can now be found in a variety of forms, serving to add to bicycle safety in a number of different ways.

The largest single change has been the popularization of safety helmet use. From a time around thirty years ago when bicycle helmet use was almost unknown, helmet use has become to ubiquitous that it has in fact become mandatory in many jurisdictions. Helmets have improved notably in comfort and ease of use as well.

Smaller changes include better visibility for bicyclists, by means of mirrors or the like, so that bicyclists on the streets may have better situational awareness as they travel or exercise by bicycle.

Making bicycles more visible to drivers of motor vehicles has also improved considerably, with better, brighter lights and so on.

However, these new safety systems are generally geared toward the traditional “worst case scenario” of biker versus vehicle. This would be natural just a few years ago because bicycling was fundamentally a road sport. That has changed in the last few years as bicycling has taken on a new dimension. In the 1970's, the “BMX” style of bicycle first became popular. BMX style bikes had very rugged frames, pegs and so on to allow riders to engage in a wider range of sports such as dirt track racing, stunting and so on. Later, riders began to engage in “off-road biking” or “mountain biking”, which allowed bicyclists to go onto a wider variety of terrain, even wild lands and city streets, and ride onto, over, off of and around all manner of obstacles from high country boulders to high way barriers.

Stunts became quite common: the bunny hop, grind, double peg, roller coaster grind, Smith grind and so on and so forth. Riders began achieve greater hang time and air time and began to deliberately reach postures and altitudes never seen before except during the most extreme accidents.

Naturally, new types of accidents began to occur, and the old fashioned safety equipment became less effective at preventing accidents or minimizing injury. To add to the problems, pupils of stunt bicycling necessarily had to teach themselves and each other, meaning that no actual safety equipment was used at all. In fact, there simply existed no safe environment for a young athlete to even learn in safety before trying their skills in the city streets or on the mountain slopes.

Helmets, elbow pads and knee pads remain effective, however, older safety devices such as lights or mirrors would merely constitute dead weight for riders who spend most of their time in environments which no motor vehicle can reach anyway, such as stairs, half tubes, mountain sides and so on.

In general, it would be beneficial to provide some sort of safety harness to minimize accidents and injuries. Attaching a rider more firmly to the bicycle (similar to the way an automobile driver is attached to their car) would be pointless, as the bicycle is not meaningful protection. A seat belt on a bicycle may actually be a safety hazard as it would restrict the rider's motion and perhaps prevent the rider from moving their bike in relation to their body, a fundamental aspect of bicycling safety.

A safety harness for bicycling would ideally be designed to prevent a rider from impacting the ground should they depart their bicycle. This is harder to arrange than it might appear. The bicyclist must be allowed to move freely in relation to the bike, but must also be allowed to move over a fairly wide area as well. And aggravating the complexity of the situation is the fact that the height of the rider is crucial in bicycling. A rider must have the bike size be proper for the type of biking being done, but must also have the seat and handlebars be properly adjusted for rider height and type of biking. A safety harness for bicycling must be adaptable to a wide range of rider heights.

Devices offering safety and protection against a possible fall have been used within commercial industries whereby workers scaled tall structures or were suspended underground to complete a task. US Patent Publication No. U.S. Pat. No. 6,804,830 published Oct. 19, 2004 in the name of Reynolds, et al. and entitled Mine Safety Appliances Company have been used for lifting and lowering individuals in dangerous situations mainly in an industrial mining setting. The reference provides a full body harness to be used in the construction industry where falls from construction platforms may be possible.

References offers a variation on the concept of safety and protection against a possible fall in the form of an arrest system. The reference in the name of Lee, US Patent Publication No. U.S. Pat. No. 6,478,112 published Nov. 12, 2002 and entitled Rail Mounted Fall Arrest Assembly, provides a similar body harness device, as Reynolds, et al. although, the harness is device is tethered to a sliding rail anchor system. This reference is intended to be used at a construction site as well as in a cave or mining operation.

U.S. Pat. No. 4,757,554 in the name of Blair and dated Jul. 19, 1988 teaches a skiers safety harness with back and neck straps which hold in place a neck cushion. The apparatus is designed for water skiers and is structured to protect the neck of the athlete during crashes and the like.

The apparatus of the '554 patent lacks a carabineer, a height adjustment device, a safety rope attached to an overhead support and so on.

U.S. Pat. No. 7,451,495 in the name of Munn et al dated Nov. 18, 2008 teaches a combined safety harness and garment. The garment/safety harness teaches straps for both shoulders and thighs which leave a large area available for webbing. Further additions include anything up to a suit covering almost the entire body of the wearer. However, it once again lacks height adjustment devices, carabineers, swivel bearings and the like.

U.S. Pat. No. 6,095,613 in the name of Ostrander et al dated Aug. 1, 2000, teaches a multi-purpose child safety harness with straps which pass about the body, shoulders, and between the legs of an infant wearer. The device allows the child to be held safety in a swing, and includes clips to attach to a swing's vertical chains. It lacks, however, a support rising from the back of the neck area and any means to allow motion, and further is so entirely constrictive (being designed for infants in swings) as to utterly prevent travel on a bicycle.

U.S. Pat. No. 7,036,628 in the name of Wilcox et al dated May 2, 2006, teaches a safety harness designed to keep a hunter in a tree-mounted hunting stand. The harness at least departs from the hunter's upper back/neck region to a tree, but it cannot provide the ability to perform bicycle stunts unless the stunts are performed around a tree. In addition, the device lacks a swivel bearing, rope, a height adjustment device and so on.

U.S. Pat. No. 5,341,896 in the name of Amacker and dated Aug. 20, 1994 teaches another design for attaching a person to a tree, this time at least allowing enough motion for the person to scale the tree. The tree-climber is attached to the tree via a strap about their waist and a rope about the tree trunk.

The device lacks structures to adjust to different heights of users, lacks mobility features to allow one to ride a bicycle and so on.

U.S. Pat. No. 6,487,725 in the name of Jordan dated Dec. 3, 2002 teaches a safety harness having an integral safety line which is semi-concealed on the body of the wearer prior to use. The rope remains looped back and forth around the torso of the wearer and has carabineers attached to it. However, the device does not allow the rope to depart upward from the neck area of the user's back nor does it allow free motion: there is no bearing swivel and so on. It also fails to teach a sturdy cantilevered support.

U.S. Pat. No. 7,073,866 in the name of Berdahl and dated Jul. 11, 2006 teaches a lower safety harness system with a strap designed to pass around a chair back or bottom or the like. The strap is fastened on with D-rings and swivel hooks at both ends, and does not connect to a solid support structure (unless a high chair is willfully mis-characterized as a solid support). The system does not leave any play or room for maneuver, in fact, it is specifically designed to restrict the infant motions. It lacks a safety rope running up above the infant, and all associated structures such as height adjustment.

U.S. Pat. No. 5,816,662 in the name of Rumburg and dated Oct. 6, 1998 teaches an “over the shoulder” safety harness of the infant high chair type, vaguely similar to that of the '866 patent. It lacks structures for fast moving athletic feats such as stunt bicycling: a cantilevered support structure above, swiveling attachments, height adjustments, and so on.

U.S. Pat. No. 5,183,007 in the name of Vincent and dated Feb. 2, 1993 teaches a motorcycle safety harness. The design, however, is not to attach the rider to a safe support structure (while still allowing riding) but rather to attach a child riding the motorcycle with an adult to the adult, so the child cannot fall off unexpectedly.

The structure lacks a sturdy support structure, swivel mounted safety rope reaching upward into the air from the back/neck area and so on.

Few references focus on a harness arrangement for recreational use although, the reference in the name of Boyer, US Patent Publication No. U.S. Pat. No. 6,390,234 published May 21, 2002 and entitled Shock Absorbing Safety Harness relates to a safety harness for use in industrial and recreational environments. The reference indicates the invention is used by an individual wearing a harness from an elevated structure. A harness is connected to a lanyard and then fastened to a scaffold.

It would be advantageous to have a device offering a safety harness with a height adjustment mechanism used specifically for bicycles in a recreational environment.

It would be preferable to provide a safe environment for a bicyclist to learn stunt bicycling.

It would be preferable to provide a safe harness which would not restrict a rider's motions on a bicycle and further would not tie the rider to the bicycle in any way.

It would further be preferable to provide a safety harness which would not just assist in avoiding accidents but would actually act to prevent a rider from impacting anything in the event of an accident involving the rider departing their bicycle.

It would further be preferable to provide a low cost and easily manufactured stunt bicycle safety harness.

### SUMMARY OF THE INVENTION

General Summary

The present invention teaches motion bicycle learning/handicap/safety harness system for bicyclists utilizing a safety harness produced from a heavy weight fabric having a padded interior and attaching, through the use of a carabineer at the front top, side or front of the harness, to a height adjustment device on a main support rope. The height adjustment device may use a knot such as a Prusik knot, another knot, a reinforced backing material having a series of loops that may allow a custom adjustment for a variety of bicyclist heights or another similar device. The physical properties of a nylon type roping material attaches via a carabineer from the height adjustment device and may allow for some stretching that may be advantageous if the bicyclist were to separate from his/her bicycle while performing a motion. The nylon type roping material may attach to a bearing swivel having a 360° turning radius. The attachment of the bearing swivel to a fixed position or a static cable between to poles may allow free movement of the bicyclist as a motion is performed or as the bicyclist traverses an obstacle course. In other embodiments, the nylon type rope may attach to a harness or itself to go over an improvised support such as a building structure, a tree limb, etc.

Summary in Reference to Claims

It is one aspect, advantage, objective and embodiment of the present invention to provide a bicycle safety harness system providing safety to a user riding a bicycle comprising:

a harness having pockets,

at least one carabineer attached to the harness,

a height adjustment device attached to the harness,

a main rope attached to the height adjustment device,

a retrieval rope,

a support engagement loop attached to the main rope and the retrieval rope.

It is one aspect, advantage, objective and embodiment of the present invention to provide a safety harness system further comprising a second carabineer attached to the support engagement loop.

It is one aspect, advantage, objective and embodiment of the present invention to provide a safety harness system wherein the height adjustment device further comprises: a short section of line having a Prusik knot therein.

It is one aspect, advantage, objective and embodiment of the present invention to provide a bicycle safety harness system providing safety to a user riding a bicycle comprising:

a harness,

at least one carabineer,

a height adjustment device,

a rope having a bearing swivel attached at a first end,

an eye bolt attached to a stable sturdy structure, the bearing swivel or a second end of the rope attached to the eye bolt and suspended therefrom,

the top of the height adjustment device attached to the lower end of the rope or the bearing swivel and thus suspended therefrom,

the carabineer attached to the height adjustment device at an intermediate loop,

the harness attached to the carabineer, the carabineer and harness thus suspended therefrom.

It is a second aspect, advantage, objective and embodiment of the present invention to provide a bicycle safety harness system providing safety to a user riding a bicycle further comprising at the harness arm holes, connective stitching, closures and a reinforced eyelet.

It is another aspect, advantage, objective and embodiment of the present invention to provide a bicycle safety harness system providing safety to a user riding a bicycle further comprising in the height adjustment device reinforced web backing material with a continuous reinforced web material sewn and looped on at least one side of the reinforced web backing material.

It is another aspect, advantage, objective and embodiment of the present invention to provide a bicycle safety harness system providing safety to a user riding a bicycle further comprising a rope material capable of marginal elasticity.

It is another aspect, advantage, objective and embodiment of the present invention to provide a bicycle safety harness system providing safety to a user riding a bicycle further comprising a 360° turning radius in the bearing swivel.

It is yet another aspect, advantage, objective and embodiment of the present invention to provide a bicycle safety harness system providing safety to a user riding a bicycle further comprising an interior padding and a durable exterior material.

It is another aspect, advantage, objective and embodiment of the present invention to provide a bicycle safety harness system providing safety to a user riding a bicycle further comprising a combination of man-made or natural materials in varying colors.

It is another aspect, advantage, objective and embodiment of the present invention to provide a bicycle safety harness system providing safety to a user riding a bicycle further comprising materials imprinted with logos, designs or script in varying colors and/or textures.

### BRIEF DESCRIPTION OF THE DRAWINGS

FIG. 1 is a side view of the first embodiment of the invention, showing a cyclist and a motion bicycle safety harness.

FIG. 2 is a front view of the first embodiment of the invention, showing a human figure with a safety harness.

FIG. 3 is a side view of the first embodiment of the invention, showing a height adjustment device.

FIG. 4 is a side view of the first embodiment of the invention, showing carabineers, roping, and bearing swivel.

FIG. 5 is a side view of the first embodiment of the invention, showing a cyclist traversing an obstacle course.

FIG. 6 is a frontal perspective view of a second embodiment of the invention.

FIG. 7a is a front elevational perspective view of the second embodiment of the invention in use on a rope line allowing easy deployment and retrieval.

FIG. 7b is a front perspective view of a third embodiment of the invention showing details of the support engagement loop.

FIG. 8 is a side view of a cyclist using the second embodiment of the invention.

FIG. 9 is a side view of the second embodiment of the invention, showing an indoor arrangement of the device of the invention.

### INDEX TO REFERENCE NUMBERS

101 Carabineer #1

102 Safety Harness

103 Bicyclist

104 Bicycle

105 Motion Bicycle Safety Harness

110 Carabineer #2

206 Rear connecting material

207 Front connector

208 Arm holes

300 Height Adjustment Device

310 Eyelet

311 Reinforced backing material

312 Reinforce material looped and attached onto reinforced backing material

410 Carabineer #2

411 Nylon type roping

412 Carabineer #3

413 Bearing Swivel

414 Carabineer #4

415 Eye bolt

416 Fixed Beam, Ceiling, and/or Cabling

500 Poles

501 Cabling

503 Obstacle Course

600 Harness

602 Tubular Body

604a, b Open ends

606 Secure point (loop)

608 Structural member (strap)

610 Closure fastener

612 Carabineer #1

614 Knot

616 Main line

618 Retrieval line

700 Bicycle

702 Rider

704 Safety lines

706 Harness

802 Main line

804 Retrieval line

806 First pocket

808 Second pocket

810 Second carabineer

812 Nylon sheath

902 Building

904 Support structure/beam

906 Attachment

908 Rope

910 Height adjustment device

912 Harness

914 Bicycle

916 Other athletic equipment

### DETAILED DESCRIPTION

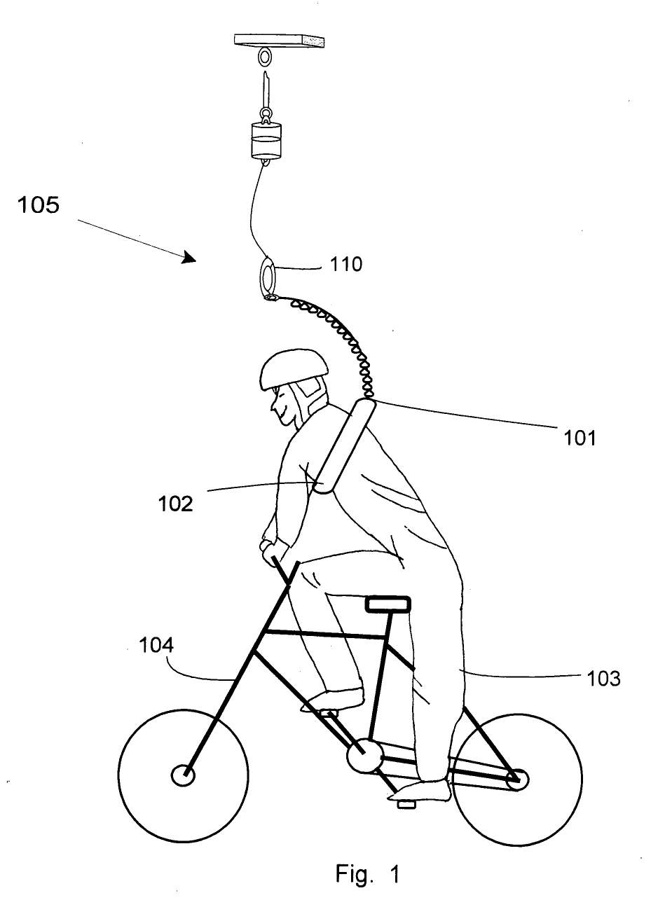

In the first mode presently contemplated for carrying out the invention a safety harness 102, as seen in FIG. 1, is worn by a bicyclist 103. The safety harness 102 may have arm holes or openings whereby the bicyclist 103 may place their arms. The arm holes of the safety harness 102 may be may be fastened or sewn together at the rear of the harness or may utilize fabric materials that may be sewn or fastened along the outside edge of the arm holes at the back of the safety harness 102. One or several connecting devices may be employed in combination at the front of the safety harness 102 and may include use of fabric, carbon fiber, metal, plastic, webbing, hook and closure, snaps or other materials suitable to connect and secure the bicyclist 103 within the safety harness 102. Leg straps may be used as well. The safety harness 102 may be manufactured from materials that are suitable for heavy use and activity. Exterior materials of the safety harness 102 may be a denim, canvas, nylon, or combination of man-made or natural materials that may carry logos, designs or script in varying colors and/or textures. Interior materials of the safety harness 102 may be man-made or natural materials that may cushion the bicyclist 103 from any tension created from the intended use. A first carabineer 101 is attached to the rear of the safety harness 102 and may be attached in an area of the safety harness 102 where tension upon the first carabineer 101 may not interfere with the comfort and safety of the bicyclist 103. Use of the motion bicycle safety harness 105 may fit the bicyclist 103 comfortably and securely while the bicyclist 103 is stationary or riding the bicycle 104.

In one low cost embodiment of the invention, the safety harness 102 may simply comprise a large elastic loop similar to a bicycle inner tube or the like. Elasticity in the safety harness is a positive quality therein, as it assists in reducing shock to the rider, allows a slightly larger margin of safety, and increases comfort level of the rider.

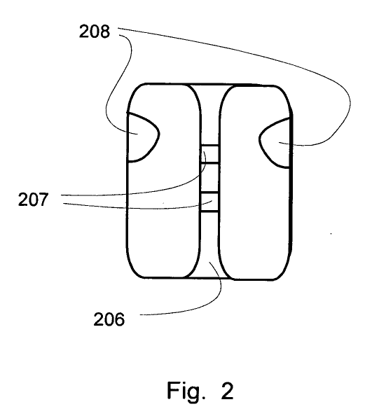

FIG. 2 indicates a front view of the invention with a human figure wearing the safety harness 102. The bicyclist 103 is shown wearing the first embodiment of the invention having their arms protrude through the arm holes 208 of the safety harness 102. Rear connecting material 206 may be seen engaging the safety harness 102. The first carabineer 101 may be fastened, adhered and/or sewn to the rear connecting material 206. A front connector 207 may be seen at the front of the safety harness 102. The front connector 207 may connect the two arm holes 208 and safety harness 102 together thereby embracing the bicyclist 103 safely and securely.

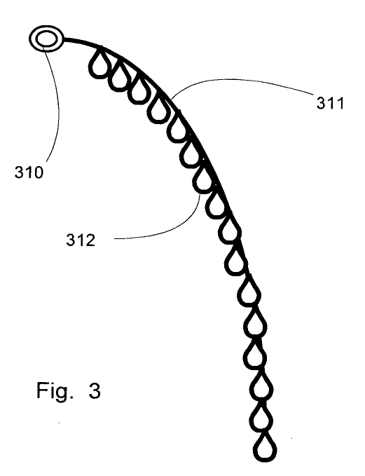

FIG. 3 is an enlarged side view of a height adjustment device 300. The height adjustment device 300 consists of a reinforced backing material 311 and a reinforced material that has been looped 312 and may be fastened or sewn onto the reinforced backing material 311. An eyelet 310 may be fastened at the top of the height adjustment device 300 within the reinforced backing material 311. The eyelet 310 may be metal, plastic, carbon fiber or any natural or man made material capable of maintaining it's physical integrity while engaged within the reinforced backing material 311. The first carabineer 101 (FIG. 1) may be connected at an appropriate loop 312 on the height adjustment device 300 and may allow custom adjustment for a variety of bicyclist 103 heights.

While height adjustment device 300 is pictured as being basically and broadly a rope, cable or similar round device, the height adjustment device may actually be a “daisy chain” of similar configuration but using flat, wide, nylon, webbing material. This webbing embodiment allows the device to be easily manufactured by sewing a flat webbing strap.

In embodiments, a second eyelet may be employed at the bottom end of the height adjustment device, so that the device could be used with either end as the upper end.

The invention teaches that the harness portion is supported from the height adjustment device/rope from a location on the rider's upper back or back of the neck, back of the shoulders, etc. This is important for safety reasons.

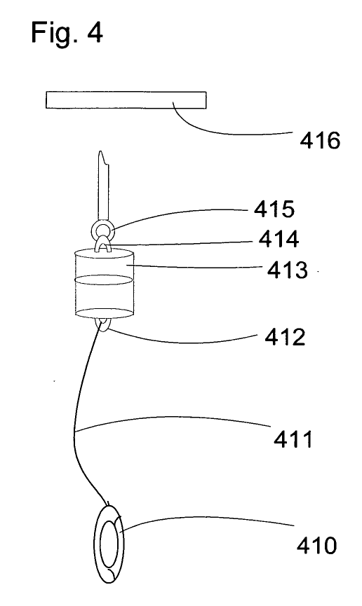

FIG. 4 is view of the first embodiment of the invention, showing second 410, and third 412 carabineers, roping 411, and bearing swivel 413. The second carabineer 410 may attach to the eyelet 310 at the top of height adjustment device 300 that in turn is connected to the safety harness 102. A nylon type rope 411 is the presently preferred embodiment and best mode presently contemplated for carrying out the invention that may attach to the second carabineer 410, though cables, chains, etc may be substituted within the scope of the invention. The physical properties of a nylon type roping 411 allow for some stretching that may be advantageous if the bicyclist 103 were to separate from his/her bicycle 104 while performing a motion. The stretching of a nylon type roping 411 may lessen any impact to the bicyclist 103. A third carabineer 412 may attach to the nylon type roping 411. The third carabineer 412 may attach to a bearing swivel 413. The bearing swivel 413 allows the free movement of the bicyclist 103 as a motion is performed, or as the bicyclist 103 traverses an obstacle course. A fourth carabineer may be placed at the upper end of the bearing swivel 413 and may attach to an eye bolt 415. The eye bolt 415 may be securely attached to a fixed beam, ceiling, tree branch and/or cabling 416, as indicated at the top of FIG. 4. The nylon type roping 411 may reach lengths of more or less than thirty feet depending upon the venue for the motion performance.

A fourth carabineer may be used above the swivel. It will be understood that carabineers are readily available, low cost, strong, easy to add and remove, and add to the great degree of freedom the device provides to the bicyclist, thus, addition of carabineers in the support chain is an easy method of altering the device to provide more flexibility.

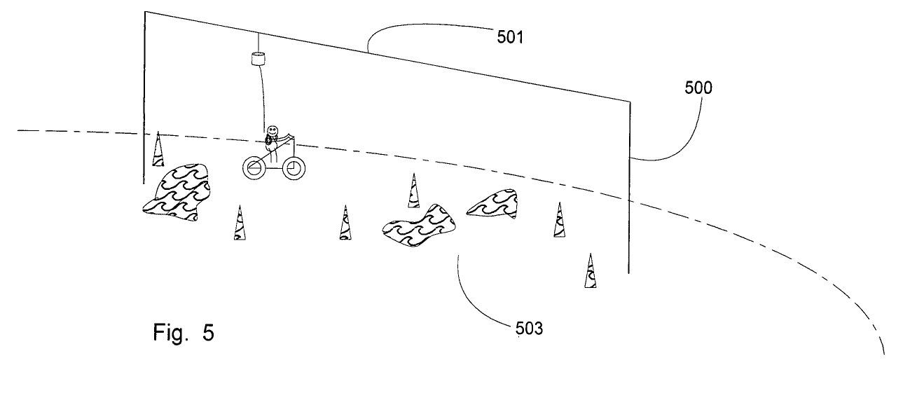

FIG. 5 indicates the invention in use by the bicyclist 103 with the motion bicycle safety harness 105 connected to cabling 501 that may be stretched taut between two poles 500. Although an obstacle course 503 illustrates the use of the motion bicycle safety harness 105, other intended motion structures may include a half tube, tube, inclined slant, or wall. The motion bicycle safety harness 105 may be used indoors or outdoors.

In one preferred embodiment of use, the device is used in a large room having a high ceiling and high walls, thus permitting year round usage. In this embodiment, tests were carried out using riders of various ages under the supervision of professional coaching staff. It was found that the riders rarely or even never suffered injury while in the safety harness. This in turn provided increased self confidence to the riders, who could more quickly take the risks necessary to increase their motion bicycling abilities.

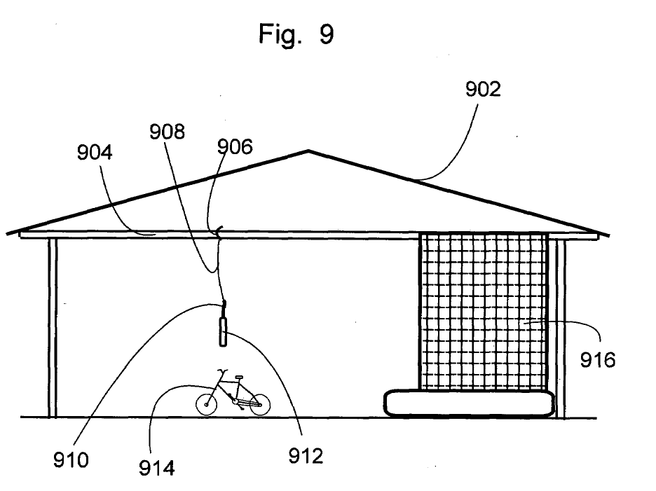

FIG. 9 is a side view of the second embodiment of the invention, showing an indoor arrangement of the device of the invention. Building 902 has an elevated support structure/beam 904. This may be specially installed for use with the invention or it may be part of the building structure. It may be supported at or near the ends, or it may be cantilevered. It may be a metal beam, wooden, polymer, composite or other suitably sturdy construction.

Attachment 906 allows the rope 908 to be firmly attached to the beam 904. The attachment 906, rope 908, beam 904 and every other element of the linkage from the support structure to the rider's actual harness must all be very strong, strong enough to withstand the weight of a person at several Gs of acceleration and high values of “jerk” (the integral of acceleration). In embodiments, the rope 908, harness, etc may be all or partially extendable so as to deform and stretch before the point at which a person would sustain injury from a non-stretching device, however, the degree of stretching should be limited both in terms of minimum imposed load and length of deformation, for obvious safety reasons.

Height adjustment device 910 may be as discussed previously and may be designed to allow riders of different heights to use the device safely.

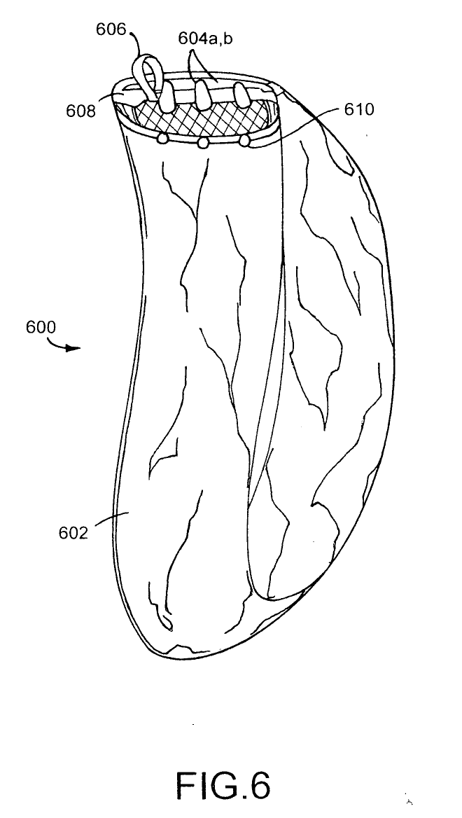

Harness 912 may be as shown in FIG. 6 et seq., a generally tubular body with rope passing through it and a proper arrangement of knots, thus allowing easy and inexpensive assembly from pre-existing components.

Bicycle 914 may be virtually any type of up-right bicycle, other athletic equipment 916 may or may not cooperate with the rider's choice of activities when the rider is provided with a safe method of riding.

The methods of using the invention are fairly straightforward.

First, the device of the invention is firmly secured to a beam, taut cable, etc, and allowed to dangle therefrom.

Secondly, a rider or coach adjusts the device (using the unique height adjuster device) to their own height of use. Notice that the height of use is somewhat complex to express but is very intuitive in practice: the rider adjusts the device so that in the event they depart the bicycle, the device will prevent them from impacting the floor or ground. This adjustment height may advantageously be a height at which the individual may have their feet on the floor or ground (and the feet may actually impact after an accident), but which nonetheless prevents their tail bone, spine, neck, head or torso from impacting. Thus, expressed structurally, this height is: the height of the bike from ground to seat plus the height of the rider from seat to harness connection (normally behind the neck) when the rider is in a proper motion bike posture.

It is also very important to have the device support the rider from the back of the neck/upper back area. Supports near to the throat are not desirable, thus the invention teaches that the harness portion is supported from the height adjustment device/rope from a location on the rider's upper back or back of the neck, back of the shoulders, etc.

Thirdly, in embodiments used outdoors, where the rider will have a taut support cable to ride along, the rider ascends to the start or top of the obstacle course.

Finally, the rider gets onto the bicycle and begins safely performing motions. The harness gives to the rider the enormous freedom of mobility desired in motion biking, for example, the rider may ride up walls, out of half tubes, take jumps as desired, etc. In the event of an accident, the rider will be prevented from actually impacting the ground with the parts of the body not suitable for impacting the ground (head, neck, spine, etc), and in the best mode, will still be allowed to have their feet hit the ground after the accident.

However, employing retrieving the device may be simplified, and the device may be made self-containing and more convenient. A presently preferred embodiment and best mode now contemplated for carrying out the invention uses a tubular harness with arrangements allowing easy and portable use, and quick and easy emplacement over a support beam of an informal nature and quick and easy retrieval therefrom. By means of these embodiments following, the device may be employed with sturdy branches of trees, with building structures such as roof beams, eaves, etc.

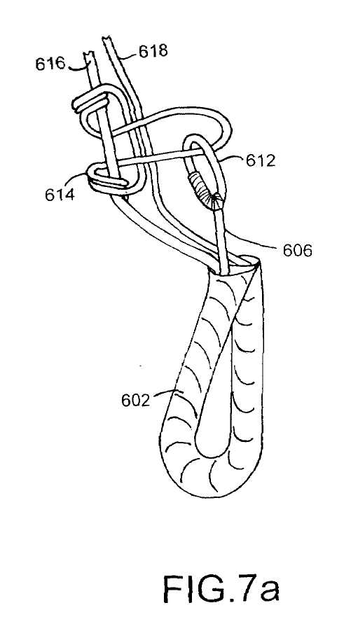

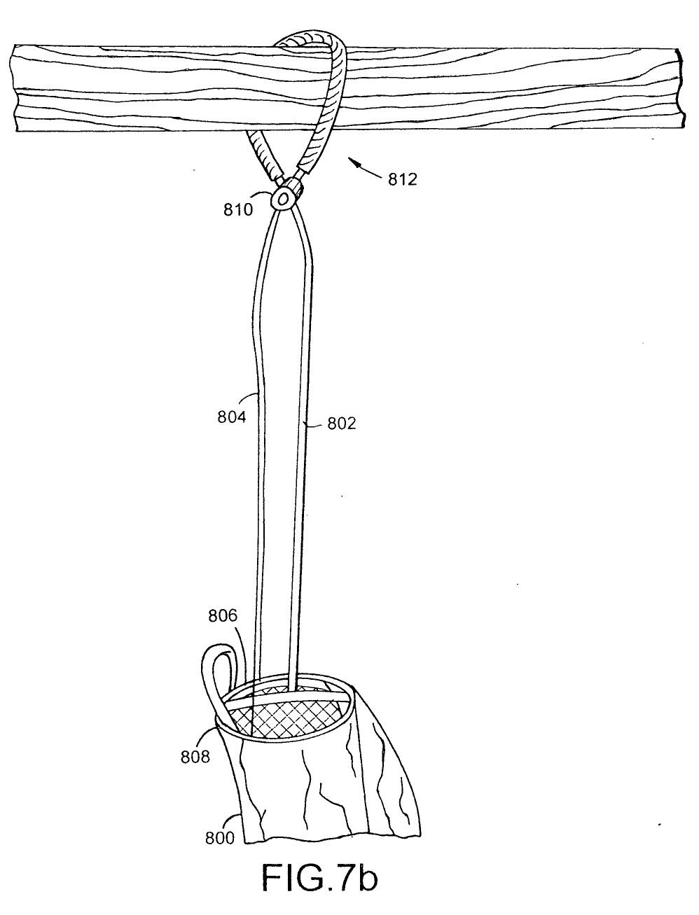

FIG. 6 is a frontal perspective view of a second embodiment of the invention. FIG. 7a is a front elevational perspective view of the second embodiment of the invention in use on a rope line allowing easy deployment and retrieval. This embodiment is presently preferred and is at this time the best mode contemplated for carrying out the invention.

Harness 600 has flexible tubular body 602 having open ends 604a, b. The open ends 604a, b are strengthened by means of a structural strength member 608 which may be a metal plate, a nylon strap, etc, and may be closed by closure fastener 610, which may be a hook and loop fabric, buttons, snaps, zips and so on. Projecting from the tubular body 602 is a secure point 606 which allows attachment of load bearing devices, in particular carabineer #1 612, a knot, or other device. Main line 616 and retrieval line 618 have one end fastened inside of the tubular body 602.

Tension taker/knot 614 may be a Prusik knot designed to take tension from one line to the loop of the knot or tension taker. It may also be another knot or similar device.

In use, carabineer #1 allows the device to take tension from the main line 616 to the loop 606 and thus to the tubular body 602 which the rider wears. This in turn means that adjustment of the position of the tension taker adjusts the overall height of the device without the necessity for changing the length of the main/retrieval line, and without the necessity of the “daisy chain” arrangement of the previous embodiment.

The height adjustment portions of this embodiment are thus simpler in structure and do not require construction of the “daisy-chain” of the earlier embodiment, and in addition allow a more exact match of height adjustment to the rider's size.

Testing has shown that height adjustment is a very important aspect of the invention. The necessity to employ a height adjustment mechanism such as the knot carabineer arrangement 612/614. (FIG. 7a is a front elevational perspective view of the second embodiment of the invention in use on a rope line allowing easy deployment and retrieval, with a particular arrangement of loop and carabineer). In particular, if the overall linkage from support structure to rider is too long, then near the center of the rideable zone (directly under the place where the attachment meets the support structure) the rider may be able to reach the ground in a fall. On the other hand, if the linkage is too short, the rideable zone shrinks as the rider is restricted by the shorter arrangement. Since rider's do not come in neat categories such as “exactly 5′ 2″”, “exactly 5′ 3″”, etc, but rather come in all sizes and in some cases, are growing quickly, it is necessary to provide a height adjustment device which allows very fine changes in length and yet will take a sudden imposed load without slipping.

Knot 614 may easily be loosened and moved up and down the rope, yet when tightened provides a grip upon the main support ropes which will not slip under imposed loads. The knot 614 is itself composed of a line, usually of smaller diameter than the main line, which is looped about the larger line several times, creates a first larger loop away from the main line, then returns and loops around the large line several times in a direction of rotation opposite to the first set of loops about the large line. A second larger loop away from the main line cooperates with the first larger loop by constricting it, preventing motion of the two sets of smaller loops (about the main line) and of the larger loop to which carabineer 614 is attached.

FIG. 7b is a front perspective view of a third embodiment of the invention showing details of the support engagement loop.

Main line 802 and retrieval line 804 are actually physically different lines in this embodiment. This also allows use of different size/nature of lines. For example, a 9 millimeter nylon climbing rope is one preferred embodiment of the invention for the main line, but a much smaller line could be used for the retrieval line in this third embodiment. Nylon climbing rope is also carefully designed with the proper degree of deformation in case of accidents, this deformation softens a fall onto the rope but does not allow significant lengthening (which would itself cause safety issues).

The tubular harness may be subdivided internally to produce two “pockets” 806 and 808 comprising the ends of the tube. Stitching may cause this subdivision. The harness material should be a sturdy fabric or composite such as nylons, polyesters, canvases and similar rugged materials.

In addition, the main and retrieval lines 802 and 804 may in fact not be physically connected, or one or both may be connected, to the tubular harness 800. This may be more convenient for deployment and retrieval, in particular when the entire harness if flung over the impromptu support beam with one line retained by the thrower, so as to provide a quick deployment.

Second carabineer 810 attached to nylon sheath 812 provides a quick link and retrieval mechanism, and provide the support member engagement loop when combined with that loop of rope which passes across/over the support member. The retrieval line may be used to pull second carabineer 810, to which it attaches, thus pulling nylon sheath 812 downwards and loosening off from the support member to retrieve. In due course, the entire main line may also be so retrieved.

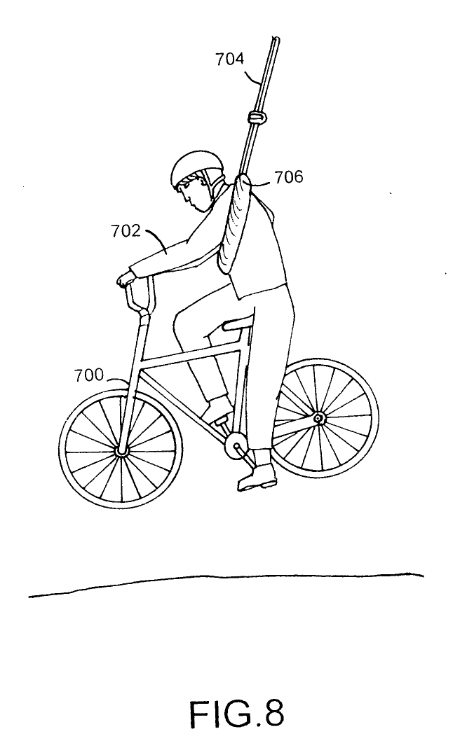

FIG. 8 is a side view of a cyclist using the second embodiment of the invention. Bicycle 700 may be off the surface of use, supported by rider 702. Safety lines 704 (the main/retrieval line) tightens to a taut state if the rider is somewhat lower, or loosens when the rider is above that height. Harness 706 safely transmits force from the rider to the safety lines.

It will be seen that in use, the second and third embodiments are easier to deploy and retrieve. The rope safety line (main/retrieval line) is stowed within the tubular body until use, then removed, and the tubular body is thrown over a support member (a beam, tree branch, etc), and retrieved, with the line now forming the main and retrieval lines. The line is fed through a loop and quick link arrangement and pulled until that loop and link reach the support beam and stop with the rope secured to the beam by its own passage over the beam and secured to itself by the loop through which it passed below the beam. When a rider's weight is applied to the main line, the tension travels via the harness, carabineer #1, knot and main line to the support member. However, when the device is no longer in use, a pull on the retrieval line lowers the loop and eventually causes the entire main line to pass over the support member and fall to the ground, where it can all be restowed in the tubular body.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying this utility application.

I claim:

1. A bicycle safety harness system providing safety to a user riding a bicycle comprising:
a harness having pockets,
at least one carabineer attached to the harness,
a height adjustment device attached to the harness,
a main rope attached to the height adjustment device at a first end of the main rope,
a retrieval rope attachable to the device and attached to the main rope at a point distal the first end,
a support engagement loop attached to the main rope and the retrieval rope.

2. The safety harness system of claim 1, further comprising a second carabineer attached to the support engagement loop.

3. The safety harness system of claim 1, wherein the height adjustment device further comprises: a short section of rope having a Prusik knot therein, passing about the main rope and securely attached thereto by the Prusik knot.

4. The safety harness system of claim 1, wherein the main rope further comprises a rope material capable of marginal elasticity.

5. The safety harness system of claim 1, wherein the main rope further comprises nylon climbing rope.

6. A bicycle safety harness system providing safety to a user riding a bicycle comprising:
a harness,
at least one carabineer,
a height adjustment device,
a rope having a bearing swivel attached at a first end,
an eye bolt attached to a stable sturdy structure, the bearing swivel or a second end of the rope attached to the eye bolt and suspended therefrom,
the top of the height adjustment device attached to the lower end of the rope or the bearing swivel and thus suspended therefrom,
the carabineer attached to the height adjustment device at an intermediate loop,
the harness attached to the carabineer, the carabineer and harness thus suspended therefrom.

7. The safety harness system of claim 6 wherein the harness further comprises arm holes, connective stitching, closures and a reinforced eyelet.

8. The height adjustment device of claim 6 further comprising reinforced web backing material with a continuous reinforced web material sewn and looped on at least one side of the reinforced web backing material.

9. The height adjustment device of claim 6 wherein rope further comprises a rope material capable of marginal elasticity.

10. The safety harness system of claim 6, wherein the main rope further comprises nylon climbing rope.

11. The safety harness system of claim 6, wherein the bearing swivel further comprises a 360° turning radius.

12. The safety harness system of claim 6 further comprising an interior padding within the harness and a durable exterior material.

13. The safety harness system of claim 6, further comprising a combination of man-made or natural materials in varying colors.
